(19) United States
(12) Patent Application Publication
(10) Pub. No.: US 2023/0401351 A1
(43) Pub. Date: Dec. 14, 2023

(54) Method and Apparatus for Obtaining a Composite Laminate

(71) Applicant: Siemens Industry Software NV, Leuven (BE)

(72) Inventors: Olga GALCHENKO, St. Petersburg (RU); Iaroslav KORKODINOV, Murino (RU)

(21) Appl. No.: 18/021,755

(22) PCT Filed: Aug. 20, 2020
(86) PCT No.: PCT/RU2020/000444

§ 371 Date: Feb. 16, 2023

(51) Int. Cl. G06F 30/17; G06F 30/27

(52) U.S. Cl. CPC G06F 30/17; G06F 2113/26; G06F 30/27

(57) ABSTRACT

A method and apparatus for obtaining a composite laminate that has plies each composed of a matrix and a filler includes receiving a model and load conditions of a mechanical part to be produced from the composite laminate, predicting properties of a candidate laminate based on features thereof by machine learning, evaluating a performance of the mechanical part produced in accordance with the model from the candidate laminate when subject to the load conditions, based on the predicted properties, optimizing the performance of the mechanical part by varying the features of the candidate laminate and repeating the predicting and evaluating steps until a desired performance is achieved; and determining the candidate laminate thus optimized as the composite laminate for manufacturing the mechanical part, where the method and apparatus can automatically obtain an optimum composite material for a given design task.

### CROSS-REFERENCE TO RELATED APPLICATIONS

This is a U.S. national stage of application No. PCT/RU2020/000444 filed 20 Aug. 2020.

### BACKGROUND OF THE INVENTION

### 1. Field of the Invention

The present invention relates to the field of manufacturing mechanical parts made from composite laminates and, more particularly, to a method and apparatus for obtaining a composite laminate comprising a plurality of plies, where each ply of the plurality of plies comprises a matrix phase and a filler phase.

### 2. Description of the Related Art

Mechanical parts made of composite laminates can significantly outperform mechanical parts made of traditional materials. Composite laminates are being used to achieve low weight combined with high durability and strength under a wide variety of loading conditions in applications, such as the manufacturing of carbon bicycle frames, land and sea vehicle bodies, and/or blades for aircraft engines.

However, the process of designing and manufacturing a mechanical part from a composite laminate is time consuming and costly. The performance of the mechanical part is largely influenced by the material properties of the composite laminate. The material properties of the composite laminate are anisotropic and depend on its material specification, i.e., on its material features at the micro-level (features of fiber and matrix), at the meso-level (fiber-matrix interactions) and at the macro level (ply-ply interactions). Computer aided engineering (CAE) simulations can be used to predict the material properties of a composite laminate at the macro-level. However, simulations at the meso-level and the micro-level are difficult and costly. Consequently, in practice, the mechanical properties of a composite laminate at the micro-level are derived using simplified, semi-empirical models, such as the Halpin-Tsai equations. That is, different and non-interrelated approaches are used to predict the material properties on the various levels. With the huge variety of possible material specifications, load conditions and restrictions, the detailed design of a mechanical part and the determination of the composite laminate for manufacturing the mechanical part require significant time, human consideration and interaction. Furthermore, the underlying simplified models and mix of different approaches may lead to imprecise results.

Stolz, Fideau, Hermann, “Homogenization of fiber composite material properties: an adaptive Multiphysics Implementation”, excerpt from the Proceedings of the 2018 COMSOL Conference in Lausanne, propose an adaptive model for calculating homogenized material properties of fiber reinforced composite materials that uses a finite element method approach.

U.S. Pat. No. 9,274,036 B2 discloses a method and apparatus that utilize an artificial neural network for directly predicting a performance (specifically, an impact resistance) of a composite material of composite pipes based on macro-level features of the composite material such as a stacking sequence of layers, a number of layers and an orientation angle of the layers.

### SUMMARY OF THE INVENTION

It is one object of the present invention to improve the design and manufacturing process of a composite laminate and a mechanical part made thereof.

This and other objects and advantages are achieved in accordance with the invention by a method for obtaining a composite laminate comprising a plurality of plies, where each ply comprises a matrix phase and a filler phase, the method comprising the computer-implemented steps of: a) receiving a geometrical model of a mechanical part to be manufactured from the composite laminate and load conditions for the mechanical part; b) acquiring material features of a candidate composite laminate; c) predicting material properties of the candidate composite laminate based on the material features by using a trained machine learning device; d) evaluating a performance of the mechanical part, when manufactured according to the geometrical model from the candidate composite laminate and loaded according to the load conditions, based on the predicted material properties; e) optimizing the performance of the mechanical part by varying the material features of the candidate composite laminate and repeatedly performing steps c) and d) until a desired performance is achieved; and f) determining the candidate composite laminate with the material features that achieve the desired performance of the mechanical part as the composite laminate from which the mechanical part is to be manufactured.

With the proposed method, it is advantageously possible to obtain a composite laminate that is optimally tailored to the mechanical part and the load conditions for which it will be used. It is thereby advantageously possible to improve the performance of a mechanical part made of the composite laminate while at the same time, the time and cost involved in designing the composite laminate can be reduced substantially.

More particularly, steps a) to f) of the inventive method are computer-implemented steps that may be performed by one or more computing devices, such as a computer, including a processor a workstation, a supercomputer having at least one processor, a computer network or a cloud, and may be fully automated. A human user may provide only the geometrical model and the load conditions of a mechanical part, and may optionally provide an initial candidate composite laminate specification, as input; and the inventive method may automatically determine the composite laminate from which the mechanical part is to be manufactured and may optionally also automatically instruct and/or cause manufacturing of the composite laminate and/or the mechanical part.

Still more particularly, the material properties of the candidate composite laminate are predicted based on the material features by using a trained machine learning device. Therefore, traditional methods of predicting the composite laminate, such as various steps of calculus, numerical analysis and simulations at various levels, can be reduced or fully eliminated and the material properties can be predicted very fast. Consequently, it is possible to explore, iteratively and automatically, a much larger number of possible candidate composite laminates and to better optimize the composite laminate in consideration of the geometrical model and the load conditions of the mechanical part.

Herein, in particular, a composite laminate is a material that is composed of a plurality of plies laminated on top of each other. Each ply is made of a respective composite material that comprises at least two phases, i.e., the matrix phase, and the filler phase. Herein, the term “matrix phase” refers to a continuous phase of the composite material of the ply. In particular, the matrix phase surrounds and covers the filler phase such that the filler phase is embedded in the matrix phase.

The matrix phase may comprise, for example, one of a polymeric material, a metallic material, and a ceramic material. In particular, examples for the polymeric material include a soft and/or ductile material, such as a synthetic resin.

The filler phase may comprise, for example, a fibrous material. The fibrous material may comprise a plurality of filler fibers. The filler fibers may be high-modulus, high-strength fibers. The filler fibers may be, for example, carbon fibers or glass fibers.

Alternatively, the filler phase may comprise a particular material. The particular material may comprise a plurality of particles. The particles may be, for example, refractory carbides.

The filler phase may be configured to reinforce the composite material.

In addition to the matrix phase and the filler phase, each ply may also include further phases, such as air entrapments, and/or binder materials.

The mechanical part may be any part, tool, and /or product, which is to be manufactured from a composite laminate.

The geometrical model may comprise CAD data, a finite element model or the like descriptive of a geometry of the mechanical part.

The load conditions may comprise data descriptive of a number of locations on the mechanical part and the forces (intensity and direction) to be applied at the respective locations.

In particular, the geometrical model and the load conditions together form a design task that is supplied by an operator as input data to the proposed method.

The term “candidate composite laminate” is used, in particular, to describe a not-yet-manufactured hypothetical composite laminate.

The material features may include, in particular, micro-level features, meso-level features and/or macro-level features of the candidate composite laminates.

More particularly, the material features may at least include micro-level features of the candidate composite laminates.

When taken together, the material features may form a specification that fully describes, i.e., which allows to manufacture, the (candidate) composite laminate.

In step b), “acquiring the material features of a candidate composite laminate” may comprise one of: receiving the material features of the candidate as an input; receiving a selection of one of a number of pre-stored default candidate composite laminates and using the material features of the selected default candidate composite laminate; or using pre-stored default material features of a pre-stored default candidate composite laminate.

For example, a user may provide the material features of a candidate composite laminate (an initial candidate composite laminate) as input to the proposed method based on his engineering knowledge. Alternatively, the user may select an initial candidate composite laminate from a plurality of default composite laminates pre-stored in an apparatus that is configured to perform the inventive method. Alternatively, no user input may be required, and the inventive method may involve using exactly one pre-stored initial candidate composite laminate. In the embodiment that involves no user input, the pre-stored initial candidate composite laminate may be a composite laminate with the simplest, or most basic, material features, or may be an industry standard composite laminate.

The machine learning device of step c) may comprise an artificial neural network or the like. For example, the machine learning device may comprise an artificial neural network of the polynomial regression type, of the tree-based type or the like. In particular, the machine learning device may have been trained to predict material properties of a candidate composite laminate based on material features thereof. In particular, the machine learning device may be capable of providing a proper and/or useful prediction of the mechanical properties of a candidate composite laminate that has not been used for training the machine learning device, without having to perform a simulation thereof.

In step c), in particular, the material properties of the candidate composite are predicted at least in part by using the trained machine learning device. At least on a micro-level, the material properties may be predicted by using the trained machine learning device, but on a macro-level and on a meso-level, the material properties could also be predicted by simulation. However, particularly beneficially, the material properties are predicted entirely and exclusively by using the trained machine learning device on all three levels.

In particular, the material properties that are predicted may include mechanical material properties. More particularly, the material properties may include local material properties. More particularly the material properties may include local continuum mechanical material properties. That is, the material properties may be suitable to for use as parameters for simulating or calculating the performance of the mechanical part to be manufactured from the composite laminate material. For example, the material properties may include a

Young modulus, a Poisson ratio, a yield stress, a stiffness, and the like. The material properties may include one or more scalar values. Alternatively, and/or in addition, the material properties may include a material property matrix. In the expression “material property matrix”, the term “matrix” refers to a plurality of scalar values that are arranged as, or may be treated as, a mathematical matrix or array.

In step d), in particular, the performance of the mechanical part may be evaluated by determining a response of the mechanical part that is subjected to load in accordance with the load conditions. The response may include the distribution of stresses or displacements throughout the mechanical part that occur in the mechanical part when subjected to the load. The response may be determined by simulation and/or by numerical and/or analytical solving. Based on the response, the performance of the mechanical part may be evaluated, likewise, through simulation, numerical solving and/or analytical solving. The performance may be a strength of the mechanical part, a durability of the mechanical part, an information as to whether and to what extent and/or after how many repetitions the mechanical part manufactured from the candidate composite laminate deforms/and or breaks when subjected to a load according to the load conditions. The performance may be a global parameter of the mechanical part.

In step e), the expression “desired performance” may refer to a predetermined desired performance, such as a lowest performance that is deemed to be acceptable, or may refer to an optimum performance, which may be the best/highest performance that can be achieved in the optimizing step, or the like.

In step e), varying the material features, in particular, relates to changing at least one of the material features and repeating steps c) and d) to determine the performance corresponding to the changed material features. The described changing and determining may be repeated one or more times until the desired performance is achieved. For example, an entire state space of possible, manufacturable, material features may be traversed to identify a globally optimum performance of the mechanical part. Alternatively, for example, step e) may implement an iterative optimization algorithm, such as a gradient descent/ascent method, to find a locally or globally optimum performance of the mechanical part.

In step f), the candidate composite laminate that has achieved the desired performance is determined as the composite laminate from which the mechanical part is to be manufactured. The material features of the composite laminate thus determined may constitute output data of the proposed computer-implemented method and may be output to an operator or to an automated device as a specification for manufacturing the composite laminate.

In this way, through use of the machine learning device in step c) and iterative optimization in step f), the inventive method may be advantageously capable of automatically obtaining a novel and/or optimum composite laminate for any given design task.

In accordance with an embodiment, the method further comprises the step of g) manufacturing the composite laminate and/or the mechanical part; and/or the computer-implemented step of g) instructing manufacturing of the composite laminate and/or the mechanical part.

That is, what is contemplated is, in particular, a fully automated, and at least partly computer-implemented, method into which a design task comprising a geometrical model and load conditions is input as input data, and a physical product, i.e., the composite laminate and/or the mechanical part, is obtained as physical output product.

In accordance with a further embodiment, the material features include at least one or more micro-level features, where each micro-level feature is a feature of the filler phase or a feature of the matrix phase of one ply of the plurality of plies.

Herein, “the material features”, in particular, relates to the material features that are received in b) and/or the material features that are used for predicting in step c) and/or the material features that are varied in step e) and or the material features that achieve the desired performance in step f).

Examples of micro-level features of a (candidate) composite laminate may include: a shape of filler fibers of the filler phase of one or more of the plies; dimensions of the filler fibers of one or more of the plies; elastic properties of the filler fibers of one or more of the plies; and elastic properties of the matrix phase of one or more of the plies.

In accordance with a further embodiment, the material features further include one or more meso-level features, where each meso-level feature is a feature indicative of a relationship between the filler phase and the matrix phase of one ply of the plurality of plies.

A “feature indicative of a relationship”, herein, may refer to a feature indicative of an interaction between the filler phase and the matrix phase.

Examples of meso-level features of a (candidate) composite laminate may include an orientation of filler fibers of the filler phase within the matrix phase of any one of the plies, a matrix to fiber ratio indicative of an amount of the filler fibers within the matrix phase of any one of the plies, and the like. The matrix to fiber ratio may be specified, for example, as a volume percentage, a mass percentage or the like. The matrix to fiber ratio may be specified with respect to the mass or volume of the matrix phase and/or the mass or volume of the entire ply, or the like.

While simulating a composite laminate at the micro-level and/or at the meso-level is cumbersome and rarely done in practice, the inventors have observed that using a machine learning device may lead to considerable improvements of the mechanical properties of a composite laminate through optimizing of the micro-features.

In accordance with a further embodiment, the material features further include one or more macro-level features, where each macro-level feature is a feature indicative of a relationship between two or more of the plurality of plies.

A “feature indicative of a relationship”, herein, may refer to a feature indicative of an interaction” between the respective plies.

Examples of macro-level features of a (candidate) composite laminate may include a number of the plies in the composite laminate; a respective type of glue between any two of the plies; a relative orientation of filler fibers of the filler phases within the matrix phases of neighboring plies; and the like.

In accordance with a further embodiment, the material features include a complete specification of micro-level, meso-level and macro-level features of the candidate composite laminate.

That is, advantageously, the method in accordance with the disclosed embodiments may enable a prediction of the material properties based on all of the micro-level, the meso-level and the macro-level material features in a single operation that can take account of or reveal hidden interdependencies between all three levels. No simulation may be required to obtain a complete and useful and/or reliable prediction of the material properties based on a complete specification of the (candidate) composite laminate, thereby greatly improving the speed of the iterative optimization loop of step e).

In accordance with a further embodiment, the material properties predicted in step c) include a material property matrix descriptive of an anisotropy of the predicted material properties.

That is, the material properties, such as a Young modulus, a Poisson ratio, a yield stress, a stiffness, and the like, may be predicted not as a respective scalar value, but as a respective matrix of scalar values that specifies these materials properties dependent on a direction within the composite laminate. In the expression “material property matrix”, the term “matrix” refers to a plurality of scalar values that are arranged as, or may be treated as, a mathematical matrix or array.

The machine learning device may easily predict the material properties as a material property matrix without requiring sophisticated calculus to account for the anisotropy.

In yet a further embodiment, during step c), the material properties are predicted solely through use of the trained machine learning device without use of simulation, without use of numerical solving, and without use of direct analytical calculations.

That is, it is beneficially possible to completely eliminate costly CAE processing and the like from the process of predicting the material properties at the micro-, meso- and macro-level.

In accordance with a still further embodiment, the inventive method further comprises the computer-implemented step of: h) training the machine learning device using material features of a respective training composite laminate as input data and material properties of the respective training composite laminate as output data.

In particular, the machine learning device may comprises an artificial neural network including an input layer of neurons that receives the micro-level, meso-level and macro-level material features as input data and an output layer of neurons that outputs the predicted material properties of the composite laminate, and may further include one or more hidden layers of neurons between the input layer and the output layer. The step of training the machine learning device may involve inputting the material features of the respective training composite laminate to the artificial neural network, measuring an error, such as a mean-squared error, between the known material properties of the respective training composite laminate and the output of the artificial neural network, and reducing the error by applying a variable weighting factor to each neuron of the artificial neural network so as to adjust an output of each neuron.

In accordance with a further embodiment, the material properties of the respective training composite laminate are determined by performing a simulation based on the material features of the training composite laminate and/or by performing a physical experiment with the respective training composite laminate.

That is, advantageously, multiple data sources may be used to train the neural network device. For example, the neural network device may be trained using a physical composite laminate, the material features and material properties of which are known and/or can be determined by performing a physical experiment. Alternatively, or in addition, a theoretical composite laminate may be used for training, and the material properties thereof may be derived using conventional techniques such as CAE simulation and/or solving simplified analytical models. Still further, data fusion may be used to combine data from various physical training composite laminates and/or theoretical training composite laminates to generate further training data sets.

In accordance with a further embodiment, during step d), the performance of the mechanical part is evaluated by performing a simulation based on the geometrical model, the load conditions and the predicted material properties.

Merely as an example, the geometrical model may be converted into a FEM model and a CAE simulation may be implemented so as to determine the response, such as the distribution of stresses and/or displacements, of the mechanical part to the load according the load conditions based on the geometrical model and the predicted local material properties, and to determine the performance of the mechanical part based on the determined response.

It is noted that any such simulation is performed at a geometry level of the mechanical part, which is a level above any of the micro-level, meso-level and macro-level of the candidate laminate.

It is noted that the disclosed embodiments of the method may involve, in particular, predicting local mechanical material parameters based on micro-level, meso-level and macro-level material features, and may involve using a simulation to determine the response of the mechanical part to the load in accordance with the load conditions. The combination of machine-learning based prediction of local material properties at the micro-, meso- and macro-level with simulation to determine the global performance of the mechanical part at the geometrical level may give the advantage of allowing the implementation of an iterative optimizing operation that ultimately determines a composite laminate that is optimized for use in manufacturing the mechanical part so as to provide optimum performance when subjected to load in accordance with the load conditions. Herein, machine-learning is used to handle the micro-, meso- and macro-level, which is difficult to handle properly using simulation and/or calculus, while simulation is used to handle the continuum mechanics at the geometry level, which is well understood and may give reliable results.

In accordance with a further embodiment, during step d), the performance of the mechanical part is evaluated using a second trained machine learning device that has been trained to predict a performance of a mechanical part based on its geometrical model, load conditions and material properties.

That is, the disclosed embodiments of the method may advantageously be performed without involving any simulations or the solving of simplified model equations at all.

By separately using a first machine learning device for predicting the material parameter and a second machine learning device for evaluating the performance of the mechanical part, it may be possible to: avoid an over-training the respective machine learning device with irrelevant data; achieve stability of the predicted material parameters for any given composite laminate independent of the geometrical model of the mechanical part to be manufactured therefrom; re-use the results obtained for a given composite laminate when the same composite laminate is applied to different mechanical parts, and the like.

In accordance with a further embodiment, step a) further includes receiving solid constraints and weak constraints for the geometrical model, and step e) includes varying the geometrical model within the weak constraints.

In particular, the respective constraints form part of the design task. The respective constraints may be included in the geometrical model or may be included in the design task independent of the geometrical model.

The strong constraints may relate to geometrical features of the mechanical part that must not be altered due to constructive and/or aesthetical reasons. The weak constraints may specify certain margins of tolerances within which the geometrical model may be altered in the iterative optimization. In this way, the proposed method may advantageously ensure manufacturability of the model part, dissolve points of stress concentration, and the like, by determining, iteratively, an optimized composite laminate and an optimized mechanical part (geometrical model thereof).

It is also an object of the invention to provide a computer program product comprising a program code for executing the computer-implemented steps of the above-described method for obtaining a composite laminate when executed on at least one computer.

A computer program product, such as a computer program means, may be formed as a memory card, USB stick, CD-ROM, DVD or as a file which may be downloaded from a server in a network. For example, such a file may be provided by transferring the file comprising the computer program product from a wireless communication network.

It is also an object of the invention to provide an apparatus for obtaining a composite laminate comprising a plurality of plies, where each ply of the plurality of plies comprises a matrix phase and a filler phase, where the apparatus comprises: a) a first unit configured to receive a geometrical model of a mechanical part to be manufactured from the composite laminate and load conditions for the mechanical part; b) a second unit configured to acquire material features of a candidate composite laminate; c) a third unit configured to predict material properties of the candidate composite laminate based on the material features by using a trained machine learning device; d) a fourth unit configured to evaluate a performance of the mechanical part, when manufactured according to the geometrical model from the candidate composite laminate and loaded according to the load conditions, based on the predicted material properties; e) a fifth unit configured to optimize the performance of the mechanical part by varying the material features of the candidate composite laminate and repeatedly causing the third unit and the fourth unit to perform their corresponding functions until a desired performance is achieved; and f) a sixth unit configured to determine the candidate composite laminate with the material features that achieve the desired performance of the mechanical part as the composite laminate from which the mechanical part is to be manufactured.

A respective unit and/or device, such as the first to fifth unit and/or the machine learning device and/or the apparatus, may be implemented in hardware and/or in software. If the entity is implemented in hardware, it may be formed as a device, e.g., as a computer or as a processor or as a part of a system, e.g., a computer system. If the entity is implemented in software it may be formed as a computer program product, as a function, as a routine, as a program code or as an executable object.

The embodiments and features described with reference to the method of the present invention apply mutatis mutandis to the apparatus of the present invention.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

### BRIEF DESCRIPTION OF THE DRAWINGS

Further embodiments, features and advantages of the present invention will become apparent from the subsequent description and dependent claims, taken in conjunction with the accompanying drawings, in which:

FIG. 1 illustrates the micro-level, meso-level and macro-level of a composite laminate in accordance with the invention.

FIG. 2 illustrates the training of a machine learning device in accordance with an exemplary embodiment.

FIG. 3 shows a flow chart of the proposed method according to an exemplary embodiment.

FIG. 4 shows a functional diagram of an optimizing apparatus in accordance with an exemplary embodiment.

FIG. 5 illustrates a workflow for manufacturing a mechanical part using the method and apparatus in accordance with the exemplary embodiments.

### DETAILED DESCRIPTION OF HE EXEMPLARY EMBODIMENTS

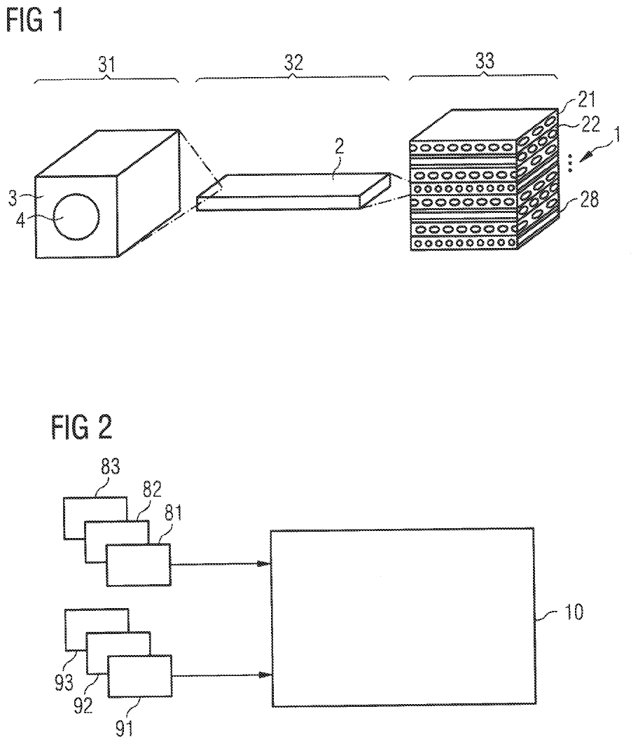

In the Figures, like reference numerals designate like or functionally equivalent elements, unless otherwise indicated. FIG. 1 illustrates a composite laminate 1 at the micro-level 31, meso-level 32 and macro-level 33. The composite laminate 1 comprises a plurality of plies 2, 21, 22, . . . , 28 that are laminated on top of each other in a vertical direction. Each ply 2 is composed of a matrix phase 3, hereinafter referred to as “matrix 3”, and a filler phase 4. In the present example, the filler phase comprises filler fibers and is referred to as “filler fibers 4” in the following. The filler fibers 4 may be glass fibers or carbon fibers.

The material properties of the composite laminate 1 depend on the material features of the composite laminate 1. A composite laminate 1 can be treated on three different structural levels, i.e., on the micro-level 31, on the meso-level 32, and on the macro-level 33.

Herein, the micro-level 31 is a level relating to the specific features of the filler fibers 4, such filler-related micro-level material features including, for example, a shape of the filler fibers 4, a dimension of the filler fibers 4, and elastic properties of the filler fibers 4; and to the specific features of the matrix 3, such matrix-related micro-level material features including, for example, the elastic properties of the matrix 4.

Further, the meso-level 32 is a level relating to the specific features of a single ply 2, or, put differently, to specific features that are indicative of a relationship, or interaction, between the filler fibers 4 and the matrix 3 that form the respective ply 2. Examples for such meso-level material features include, for example, an orientation of the filler fibers 4 within the matrix 3 in the ply 2, a matrix to fiber ratio indicative of an amount, such as a mass percentage or a volume percentage, of the filler fibers 4 within the matrix 3 in the ply 2, and the like.

Further, the macro-level 33 is a level relating to the specific features of the laminate 1, which comprises a plurality of plies 21, 22, . . . , 28. In other words, examples of macro-level material features are features that are indicative of a relationship, or interaction, between any two neighboring of the plies 21, 22, 28. Examples of such macro-level material features include a number of the plies 21, 22, . . . 28 in the composite laminate 1; a respective type of glue between any two of the plies 21, 22, . . . 28; a relative orientation of the fibers 3 within the matrixes 4 of neighboring plies 21, 22, . . . 28; and the like.

All of the above-mentioned micro-level 31, micro-level 32, and macro-level 33 material features of the composite laminate 1 influence the material properties (in particular, the local continuum mechanical material properties) of the composite laminate 1. However, there is no efficient and practical coherent approach for analytically and/or numerically deriving the material properties of a composite laminate 1 based on the material features at all three levels 31, 32, 33.

FIG. 2 illustrates the training of a machine learning device in accordance with an exemplary embodiment. The machine learning device 10 may comprise an artificial neural network or any other type of trainable machine learning and/or artificially intelligent device.

In a first training step, a physical training composite laminate (not shown) is chosen, the material features 81 and material properties 91 of which are known from and/or are being obtained from conducting a physical experiment. The training material features 81 of the physical training composite laminate are provided to the machine learning device as input data, and the known material properties 91 of the physical training composite laminate are provided to the machine learning device 10 as target output data. In this way, the machine learning device 10 is trained to know that the material features 91 are the desired output data for the material features 81 as input data. The machine learning device 10 may achieve the learning/training, for example, by applying weighting factors to the outputs of each neuron of its artificial neural network, or the like.

In a second training step, a theoretical training composite laminate (not shown) is chosen, the material features 82 of which are specified, and the material properties 92 of which are obtained by calculation and/or simulation. For example, at the micro-level 31, the material properties 92 may be derived by solving a set of Halpin-Tsai equations, while at the meso-level 32 and the macro-level 33, the material properties 92 may be derived by performing a FEM based CAE simulation. The training material features 82 and the training material properties 92 of the theoretical training composite laminate are provided to the machine learning device 10 as training input/output data in the same manner as has been described for the first training step.

In a third training step, data fusion is applied to generate a further set of training material features 83 and training material properties 93 from the existing training material features 81, 82 and the existing training material properties 91, 92. The data-fused training material features 83 and the data-fused training material properties 93 are provided to the machine learning device 10 as training input/out data in the same manner as has been described for the first and second training steps.

In the manner describe above, a trained machined learning device 10 may be achieved.

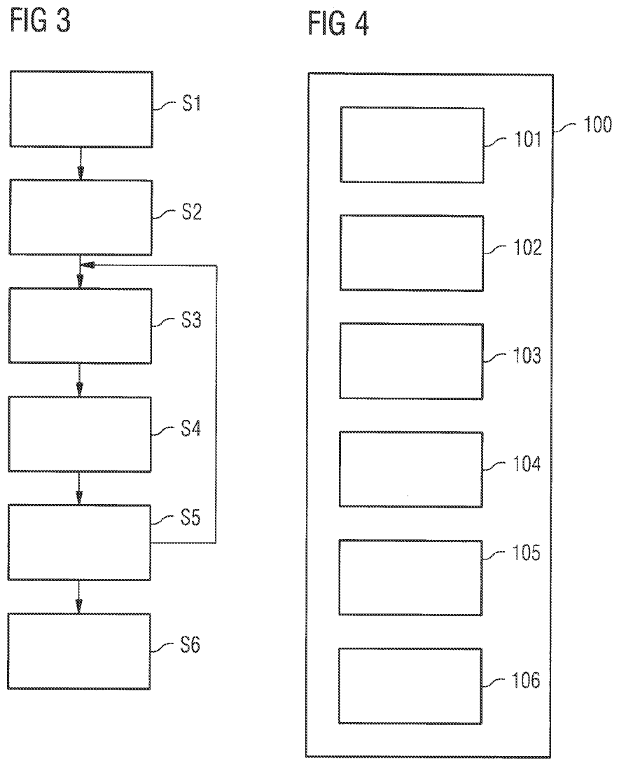

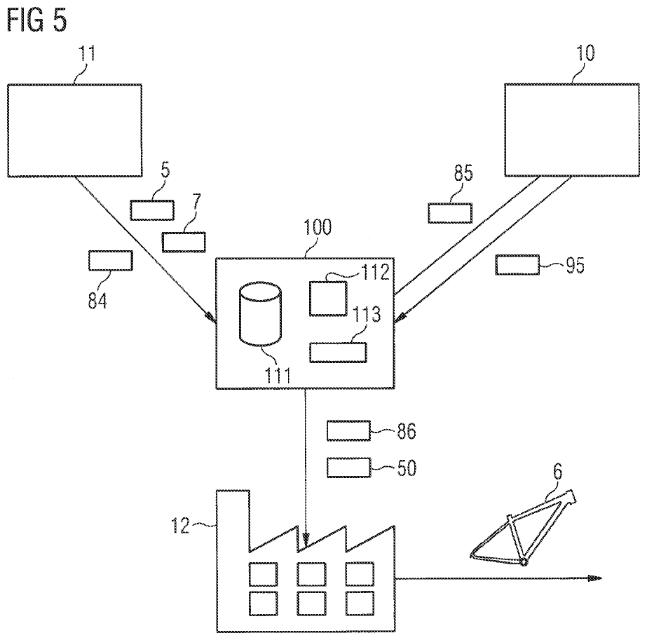

FIG. 3 shows a flow chart of the inventive method in accordance with an exemplary embodiment; FIG. 4 shows a functional diagram of an optimizing apparatus 100 according to the exemplary embodiment, and FIG. 5 illustrates a workflow for manufacturing a mechanical part 6 using the method and apparatus 100 of exemplary embodiments.

A preferred exemplary embodiment is described below with reference to FIGS. 3 to 5, and FIG. 1, as appropriate.

The workflow shown in FIG. 5 involves a user interface device 11, a machine learning device 10, an optimizing apparatus 100 and a production facility 12.

In particular, the optimizing apparatus 100 includes a storage device 111, such as a hard drive or solid-state disk, a processor 112, such as a central processing unit, and a memory 113, such as a random access memory. The storage device 11, processor 112 and memory 113 shown in FIG. 5 are operatively coupled to form or comprise, when working in cooperation, the functional units (first unit 101, second unit 102, third unit 103, fourth unit 104, fifth unit 105 and sixth unit 106) of the optimizing apparatus 100 shown in FIG. 4.

In particular, the user interface device 11 may be a computer aided design (CAD) workstation or the like upon which a design engineer creates a geometrical mode 5 and load conditions 7 for a mechanical part 6 to be manufactured from a composite laminate 1.

In the illustrated example, the mechanical part 6 is a “carbon” bicycle frame, and the composite laminate 1 is a carbon fiber reinforced polymer, i.e., the filler fibers 4 are carbon fibers, and the matrix 3 is a polymer material.

In particular, the machine learning device 10 of FIG. 5 may be the trained machine learning device 10, the training of which has been described in connection with FIG. 2.

In step S1 of the method in accordance with the present exemplary embodiment, the first unit 101 of the optimizing apparatus 100 receives the geometrical model 5 and the load conditions 7 of the mechanical part 6.

For example, the geometrical model 5 may be a three-dimensional CAD model, and the load conditions may be a map of the maximum loads that are expected to act upon the bicycle frame 5 when a rider (not shown) sits on a saddle mounted on the bicycle frame 6; when a bicycle, which includes the bicycle frame 6, drives over a bump on a trail, performs a jump, and the like.

In step S2, the second unit 102 of the optimizing apparatus 100 receives material features 84 of a candidate composite laminate 1 that have been specified by the design engineer.

In particular, the material features 84 received in step S2 are then used by the optimizing apparatus 100 as the material features 85 of a candidate composite laminate 1 of a current iteration.

In step S3, the third unit 103 provides the material features of the candidate composite laminate 1 of the current iteration to the trained machine learning device 10 as input data and receives, as output data from the trained machine learning device 10, predicted material features 95 of the candidate composite laminate 1 of the current iteration.

In step S4, the fourth unit 104 evaluates a performance of the mechanical part 6. That is, the fourth unit 104 uses the predicted material properties 95 to evaluate a response of the mechanical part 6 (hypothetical mechanical part 6) if it were manufactured from the candidate composite laminate 1 of the current iteration and subjected to load according to the load condition 7; and determines the performance of such a hypothetical mechanical part 6 based on the determined response.

Merely as an example, the fourth unit 104 may use a FEM model of the mechanical part 6 generated from the CAD model 5 to perform a simulation of the FEM model using the load conditions 7 and the material properties 95 as parameters of the simulation.

In step S5, the fifth unit 105 decides whether the performance evaluated in step S4 is the desired performance.

If the performance is not the desired performance, then the fifth unit 105 optimizes the performance of the mechanical part 6 by optimizing the material properties 95 of the candidate laminate 6.

In particular, for the optimization, the firth unit 105 varies at least one of the features included in the material features of the candidate laminate 1 of the current iteration to achieve material features of the candidate composite laminate 1 of a next iteration. Then, the candidate composite laminate 1 of the next iteration is made to be the candidate composite laminate 1 of the new current iteration, i.e., the varied material features are used as the material features 85 used in the new current iteration. Then, the fifth unit 105 causes repetition of steps S3 and S4, and S5, with the material features 85 of the candidate composite laminate 1 of the new current iteration.

In particular, for determining how to vary which of the material properties 85, the fifth unit 105 may apply a traversal method, a gradient ascent (gradient decent) method, or any other solving method that is adapted to identify a local or global optimum for a function that can be evaluated, but is not analytically known.

In performing the varying, the fifth unit 105 may take into account soft constraints or hard constraints relating to manufacturability and the like that may be included in the geometrical model 5 or may be inputted separately.

If the performance evaluated in step S4 is the desired performance, i.e., for example, if a predetermined threshold performance is achieved and/or if the solving method applied indicates that a local or global optimum has been achieved, then step S5 proceeds to step S6.

In step S6, the sixth unit 106 determines that the candidate laminate 1 of the current iteration, which was determined in step S5 to have achieved the desired performance of the mechanical part 6, is the composite laminate 1 from which the mechanical part 6 is to be manufactured. In particular, the sixth unit 106 provides the material features 85 of the current iteration as material features 86 of the composite laminate 1 from which the mechanical part 6 is to be manufactured.

More particularly, the material features 86 that are provided by the sixth unit 106 may include micro-level 31, meso-level 32 and macro-level 33 features that form a complete, manufacturable, specification of the obtained composite laminate 1.

That is, the method and apparatus of the present exemplary embodiment may advantageously allow, in a fully automated manner, a complete specification for manufacturing a composite laminate 1 that is tailored to a design task to be obtained and achieves a desired and/or optimum performance of the mechanical part 6. The only input required to specify the design task may be the geometrical model 5 of the mechanical part 6 and the load conditions 7 that the mechanical part 6 is to be subjected to (that it shall withstand).

As a further development of the inventive method and optimization apparatus 100, the sixth unit 106 may perform a further step of providing the manufacturable specification 86 of the obtained composite laminate to the production facility 12 and instruct and/or cause the production facility 12 to automatically manufacture the composite laminate 1, or to manufacture both the composite laminate 1 and the mechanical part 6.

The machine learning device 10 has been described as a device that is external to the proposed optimizing apparatus 100. However, the optimizing apparatus 100 may also comprise the machine learning device 10.

In step S2 of the preferred exemplary embodiment, the second unit 102 of the optimizing apparatus 100 acquires the material features 84 of a candidate composite laminate 1 by receiving the material features 84 that have been specified by a design engineer from the user interface device 11. Alternatively, the second unit 102 may also merely receive a selection from the user interface device 11, where the selection specifies one of several default candidate composite laminates 1 that may be pre-stored in the storage device 111 of the optimizing apparatus 100. Alternatively, in step S2, the second unit 102 may acquire the material features 84 of an initial candidate composite laminate 1 without requiring any input to be received from the user interface device 11. The second unit 102 may select one of several pre-stored default candidate composite laminates based on a preliminary analysis of the received geometrical model 5, or the second unit 102 may always select a single, same default candidate composite laminate 1 that is pre-stored in the storage device 111, for example.

The material features 84 of the initial candidate laminate, the material features 85 of the candidate laminate of the current iteration, and the material features 86 of the obtained composite laminate may include any of the mentioned or other conceivable micro-level 31, meso-level 32 and macro-level 33 features that are suitable for providing a manufacturable specification of material features of a composite laminate 1.

It has been described that in step S3, the third unit 103 provides all of the material features 85 of the candidate laminate 1 of the current iteration to the machine learning device 10 to predict the material properties 95 of the candidate laminate 1 of the current iteration. However, only some of the material features 85 may be provided to the machine learning device 10 and only some of the material properties 95 may be predicted by the machine learning device and computer aided engineering simulations may be used to complement the machine learning device 10. For example, the material properties 95 can be predicted by machine learning at least on the micro-level 31, and can be predicted by simulation or by calculation at least on the macro-level.

By using the machine learning device 10, the material properties 95 may be predicted easily and efficiently as a material property matrix that accounts for an anisotropy of the properties of the composite laminate 1 that is caused by the arrangement of the specific filler fibers 4, plies 2 and the like.

It has been described that in step S4, the fourth unit 104 evaluates the response of the mechanical part 6 to the load according to the load conditions 7 by performing a simulation on a FEM model of the mechanical part 6. However, the fourth unit 104 may also apply analytical and/or other numerical approaches to evaluate the response. In yet another alternative, a further machine learning device (not shown) may be used to predict the response and/or the performance of the mechanical part 6 based on the predicted material properties the load conditions 7 and the geometrical model 5.

It has been described that in step S5, the fifth unit 105 varies the mechanical features 85 of the current iteration to optimize the performance of the mechanical part 6 by optimizing the mechanical properties 95 of the composite laminate 1 of the current iteration. However, in addition to that, the fifth unit 105 may also vary the geometric model 5 of the mechanical part 6 to further optimize the performance of the mechanical part 6, to ensure manufacturability of the composite laminate 1 and the mechanical part 6, and the like. For example, the geometrical model 5 may comprise weak constrains that specify which portions of the geometrical model 5 may be varied to what extent, and solid constraints that specify which portions of the geometrical model 5 must not be varied. In the presently contemplated embodiment, the sixth unit 106 may provide (to an operator or the production facility 12), not only the specification of material features 86 of the obtained composite laminate 1, but also the optimized geometrical model 50 of the mechanical part 6.

As an example of the mechanical part 6, a bicycle frame has been described. However, the teachings of the present disclosure are not limited thereto, and are also applicable to any design task that could potentially be solved using a composite laminate 1, such as a blade for an aircraft engine, a vehicle or boat body, and the like.

Moreover, the method and apparatus in accordance with embodiments of the invention advantageously may provide a fully automated and fast method and apparatus for determining and/or manufacturing composite laminate material that is optimized for solving any arbitrary design task. It is thus expected that the present invention may lead to new kinds of mechanical parts 6 being specified and manufactured from composite laminate materials that conventionally would not have been realized using a composite laminate due to an excessive amount of difficult, time-consuming, manual and/or computationally costly tasks involved in determining a suitable composite laminate and/or geometrical model when using conventional design and/or manufacturing techniques.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A computer-implemented method for obtaining a composite laminate comprising a plurality of plies, each ply of the plurality of plies comprising a matrix phase and a filler phase, the method comprising:
a) receiving a geometrical model of a mechanical part to be manufactured from the composite laminate and load conditions for the mechanical part;
b) acquiring material features of a candidate composite laminate;
c) predicting material properties of the candidate composite laminate based on the material features via a trained machine learning device;
d) evaluating a performance of the mechanical part, when manufactured in accordance with the geometrical model received from the candidate composite laminate and loaded in accordance with the load conditions, based on the predicted material properties;
e) optimizing a performance of the mechanical part by varying the material features of the candidate composite laminate and repeatedly performing steps c) and d) until a desired performance is achieved; and
f) determining the candidate composite laminate with the material features that achieve the desired performance of the mechanical part as the composite laminate from which the mechanical part is to be manufactured.

17. The method of claim 16, further comprising:
g) at least one of (i) manufacturing at least one of the composite laminate and the mechanical part and (ii) instructing via a computer at least one of manufacturing of the composite laminate and the mechanical part.

18. The method of claim 16, wherein the material features include at least one or more micro-level features, each micro-level feature being one of a feature of the filler phase and a feature of the matrix phase of one ply of the plurality of plies.

19. The method of claim 17, wherein the material features include at least one or more micro-level features, each micro-level feature being one of a feature of the filler phase and a feature of the matrix phase of one ply of the plurality of plies.

20. The method of claim 18, wherein the material features further include one or more meso-level features, each meso-level feature being a feature indicative of a relationship between the filler phase and the matrix phase of one ply of the plurality of plies.

21. The method of claim 18, wherein the material features further include one or more macro-level features, each macro-level feature being a feature indicative of a relationship between two or more of the plurality of plies.

22. The method of claim 20, wherein the material features further include one or more macro-level features, each macro-level feature being a feature indicative of a relationship between two or more of the plurality of plies.

23. The method of claim 16, wherein the material features include a complete specification of micro-level, meso-level and macro-level features of the candidate composite laminate.

24. The method of claim 16, wherein the material properties predicted in step c) include a material property matrix descriptive of an anisotropy of the predicted material properties.

25. The method of claim 16, wherein, during step c), the material properties are predicted solely through use of the trained machine learning device without use of simulation, without use of numerical solving, and without use of direct analytical calculations.

26. The method of claim 16, further comprising:
h) training the machine learning device utilizing material features of a respective training composite laminate as input data and material properties of the respective training composite laminate as output data.

27. The method of claim 26, wherein the material properties of the respective training composite laminate are determined by performing at least one of (i) a simulation based on the material features of the training composite laminate and (ii) a physical experiment with the respective training composite laminate.

28. The method of claim 16, wherein, during step d), a performance of the mechanical part is evaluated by performing a simulation based on the geometrical model, the load conditions and the predicted material properties.

29. The method of claim 16, wherein, during step d), a performance of the mechanical part is evaluated using a second trained machine learning device that has been trained to predict a performance of a mechanical part based on a geometrical model, load conditions and material properties of the mechanical part.

30. The method of claim 16, wherein, said step a) further includes receiving solid constraints and weak constraints for the geometrical model; and wherein step e) further includes varying the geometrical model within the weak constraints.

31. A computer program product comprising program code for executing the computer-implemented method of claim 16 when executed on at least one computer.

32. An apparatus for obtaining a composite laminate comprising a plurality of plies, each ply of the plurality of plies comprising a matrix phase and a filler phase, the apparatus comprising:
a) a first unit configured to receive a geometrical model of a mechanical part to be manufactured from the composite laminate and load conditions for the mechanical part;
b) a second unit configured to acquire material features of a candidate composite laminate;
c) a third unit configured to predict material properties of the candidate composite laminate based on the material features by utilizing a trained machine learning device;
d) a fourth unit configured to evaluate a performance of the mechanical part, when manufactured according to the geometrical model from the candidate composite laminate and loaded in accordance with the load conditions, based on the predicted material properties;
e) a fifth unit configured to optimize a performance of the mechanical part by varying the material features of the candidate composite laminate and repeatedly causing the third unit and the fourth unit to perform their corresponding functions until a desired performance is achieved; and
f) a sixth unit configured to determine the candidate composite laminate with material features that achieve the desired performance of the mechanical part as the composite laminate from which the mechanical part is to be manufactured.
